(19) United States
(12) Patent Application Publication
(10) Pub. No.: US 2013/0109275 A1
(43) Pub. Date: May 2, 2013

(54) MAN-MADE BEE HOUSING APPARATUS

(71) Applicant: Carl Jackson, Corbin, KY (US)

(72) Inventor: Carl Jackson, Corbin, KY (US)

(21) Appl. No.: 13/283,977

(22) Filed: Oct. 28, 2011

(51) Int. Cl. A01K 47/06

(52) U.S. Cl. 449/16; 449/20; 449/21

(57) ABSTRACT

A man-made bee housing configured to be maintained in a substantially vertical orientation but including features allowing for a primary compartment to be rotated to a substantially horizontal orientation to facilitate removal of honey, inspection of bees, and other maintenance needs.

### FIELD

This disclosure relates to the field of domestic bee-keeping. More particularly, this disclosure relates to man-made structures for housing bees.

### BACKGROUND

Domesticated bee-keeping technology has advanced substantially over the past couple of centuries, but one thing that has not changed much at all since the 1860s is housing for domesticated bees. In 1860, Lorenzo Langstroth obtained U.S. Pat. No. 9,300 on a man-made bee hive design that is still primarily used today. Although many of the features of the Langstroth man-made bee housing design were revolutionary when conceived and still are used today including Langstroth frames and associated spacing, one drawback is the requirement to manually lift rectangular boxes to extract honey from a hive inside the housing. These boxes can weigh up to about 60 pounds when fully loaded with beehive structure and honey. During certain seasons, it is desirable for a bee keeper to check on the queen bee in a beehive at least about every ten days or so. Thus, lifting and moving multiple heavy boxes takes a toll on the bee keeper is simply not possible for some people.

Nonetheless, the substantially vertical arrangement of the Langstroth man-made bee housing is actually the manner in which bees in nature build their hives. Thus, there is evidence in nature that bees prefer a substantially vertical orientation for their bee hives.

What is needed, therefore, is a man-made bee housing that is maintained in a substantially vertical orientation but that is accessible to persons of all ages and capability levels (including, e.g., persons unable to lift a heavy box from a Langstrooth device).

### SUMMARY

The above and other needs are met by a man-made bee housing apparatus that is maintained in a vertical orientation yet is readily rotated to a horizontal orientation to provide access to users of varying ages and capability levels.

In a preferred embodiment, a man-made bee housing is comprised of a primary enclosure including a plurality of walls, a first door, and an entrance aperture, the primary enclosure defining a primary compartment, the first door for accessing the primary compartment, and the entrance aperture providing a means of ingress and egress for bees to and from the primary compartment; a rotation element connected to the primary enclosure; and a support structure attached to the rotation element, wherein the primary enclosure is rotatable about an imaginary axis from a substantially vertical orientation to a substantially horizontal orientation and vice versa. In an alternative embodiment, the man-made bee housing includes a door located along at least a portion of the top of the primary enclosure when the primary compartment is oriented in a substantially horizontal orientation. In yet another embodiment, the man-made bee housing is further comprised of a catch member for providing supplemental support to the primary enclosure when the primary enclosure is in a substantially horizontal orientation. In another embodiment, the man-made bee housing is further comprised of a plurality of sub-compartments defined within the primary compartment, each sub-compartment separated by a partial barrier, wherein one of the sub-compartments comprises a brooding chamber.

In an additional embodiment, the rotation element of the man-made bee housing further comprises a coupling member connected to and extending outwardly from a first side panel of the primary enclosure and oriented along the imaginary axis; and wherein the support structure further comprises a first beam including a trunk member and a ring member proximate a first end of the trunk member for engagement with the coupling member, thereby providing a rotational connection between the primary enclosure and the support structure. In yet another embodiment, the rotation element of the man-made bee housing further comprises a second coupling member connected to and extending outwardly from a second side panel of the primary enclosure and oriented along the imaginary axis; and wherein the support structure further comprises a second beam including a trunk member and a ring member proximate a first end of the trunk member for engagement with the second coupling member. In another alternative embodiment, the rotation element further comprises a coupling member connected to the primary enclosure; and wherein the support structure further comprises a first beam including a trunk member and an arm member, the arm member extending substantially orthogonal from the trunk member and oriented along the imaginary axis through an aperture defined at least in part by the coupling member to provide a rotational connection between the primary enclosure and the support structure. In another embodiment, the rotation element further comprises a coupling member connected to the primary enclosure; and wherein the support structure further comprises an arm member extending substantially horizontally, oriented along the imaginary axis through an aperture defined at least in part by the coupling member to provide a rotational connection between the primary enclosure and the support structure.

In yet another embodiment, the man-made bee housing is further comprised of a plurality of sub-compartments including a first sub-compartment, a second sub-compartment, and a third sub-compartment; wherein the first sub-compartment is located at the lowest elevation when the primary enclosure is oriented in a substantially vertical orientation; and wherein the volume of the sub-compartment comprising the brooding chamber is greater than any other sub-compartment that does not include the brooding chamber. In an alternative embodiment, the first sub-compartment comprises the brooding chamber. In another embodiment, the man-made bee housing further comprises a plurality of sub-compartments including a first sub-compartment, a second sub-compartment including the brooding chamber, and a third sub-compartment; wherein the first sub-compartment is located at the lowest elevation when the primary enclosure is oriented at a substantially vertical orientation; wherein the volume of the second sub-compartment is greater than the volume of the first sub-compartment and wherein the volume of the third sub-compartment is greater than the volume of the first sub-compartment.

In an alternative embodiment, the man-made bee housing is further comprised of a second door and a third door, wherein the first door provides access to the first sub-compartment, the second door provides access to the second sub-compartment, and the third door provides access to the third sub-compartment. In another embodiment, the man-made bee housing is comprised of a plurality of frames removably attached to the primary enclosure inside the primary compartment. Alternatively, the man-made bee housing further includes a landing board extended outwardly adjacent the entrance aperture.

In another aspect, embodiments of the man-made bee housing further include a gear assembly including a hand crank, the gear assembly connected to the primary enclosure and providing mechanical advantage for a user to rotate the primary enclosure from a substantially vertical orientation to a substantially horizontal orientation and vice versa. In an alternative embodiment, the man-made bee housing further comprises a gear assembly connected to the primary enclosure and an electric motor mechanically engaged with the gear assembly, the gear assembly providing mechanical advantage and the electric motor providing automation for rotating the primary enclosure from a substantially vertical orientation to a substantially horizontal orientation and vice versa. In yet another alternative embodiment, the man-made bee housing comprises a pulley assembly connected to the man-made bee housing, the pulley assembly providing mechanical advantage for rotating the primary enclosure from a substantially vertical orientation to a substantially horizontal orientation and vice versa. In another aspect, the man-made bee housing further comprises a cord connected to the primary enclosure and wound about a spool; and an electric motor for winding and unwinding the cord along the spool to rotate the primary enclosure from a substantially vertical orientation to a substantially horizontal orientation and vice versa.

In another embodiment, the man-made bee housing further comprises an insertion aperture and a cap for blocking the insertion aperture, the insertion aperture sized and shaped to hold a cage used to introduce a new queen bee to any colony of bees housed within the man-made bee housing, the cage temporarily housing a queen bee and including an exit aperture facing the primary compartment.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 shows a schematic representation of a man-made bee housing as described herein;

FIG. 2 shows a schematic side view of a man-made bee housing as described herein;

FIG. 3 shows a schematic plan view of a man-made bee housing as described herein;

FIG. 4A shows a schematic end view of a man-made bee housing as described herein wherein a primary enclosure has been rotated to a substantially vertical orientation;

FIG. 4B shows a schematic side view of a man-made bee housing as described herein wherein the primary enclosure of FIG. 4A has been rotated to a substantially horizontal orientation;

FIG. 4C shows a schematic plan view of a support structure excluding the primary enclosure of FIGS. 4A-4B;

FIG. 4D shows a schematic plan view of the primary enclosure of FIGS. 4A-4B;

FIG. 5A shows a somewhat schematic cross-sectional view of the primary enclosure of FIGS. 4A, 4B, and 4C as cut across line A-A in FIG. 4A;

FIG. 5B shows a somewhat schematic cross-sectional view of the primary enclosure of FIGS. 4A, 4B, and 4C as cut across line B-B in FIG. 4A;

FIG. 6A shows a schematic side view of an example of a primary enclosure;

FIG. 6B shows a schematic end view of a man-made bee housing including the primary housing of FIG. 6A and including a support structure;

FIG. 6C shows a schematic end view of a man-made bee housing including the primary housing of FIG. 6A and including an alternate support structure;

FIG. 7 shows a schematic side view of a man-made bee housing including a gear assembly;

FIG. 8A shows a schematic side view of a man-made bee housing including a motor for driving a spool of cord; and

FIG. 8B shows a schematic plan view of a support structure used to hold a primary enclosure for the man-made bee housing shown in FIG. 8A; and

FIG. 9 showing a schematic side view of a man-made bee housing including a pulley system for rotating a primary enclosure of the man-made bee system.

### DETAILED DESCRIPTION

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

Substantially vertical orientation: a position wherein a lengthwise orientation of an object is aligned with the directional force of Earth's gravity within +/−25°.

Substantially horizontal orientation: a position wherein a lengthwise orientation of an object is positioned orthogonal to the directional force of Earth's gravity within +/−25°.

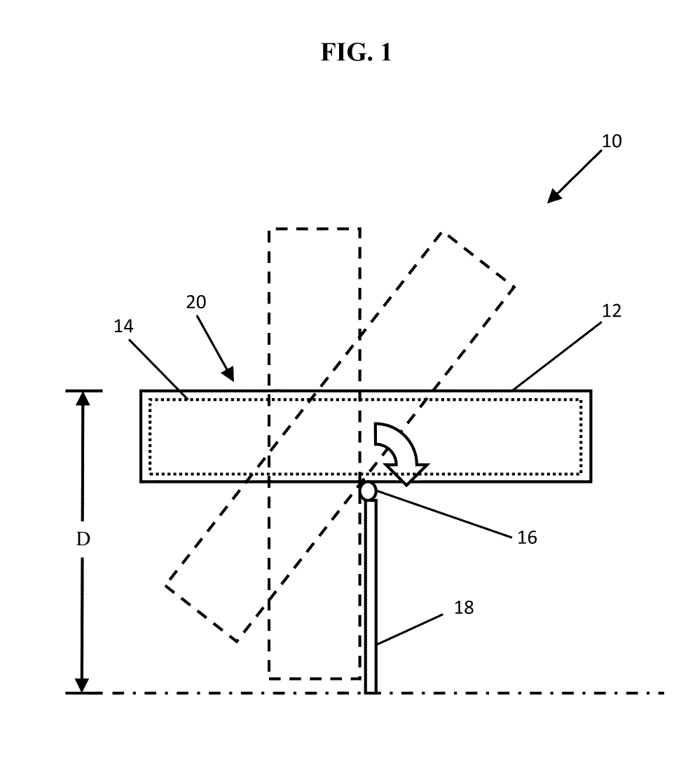

FIG. 1 shows a schematic view of features of a man-made bee housing 10 including a primary enclosure 12 defining a primary compartment 14, a rotation element 16, and a support structure 18. The top 20 of the primary enclosure (when in a substantially horizontal orientation) is preferably a distance D of from about 2 feet (ft) to about 5 ft and more preferably from about 3 ft to about 4 ft from the local ground level for easy access to the primary compartment.

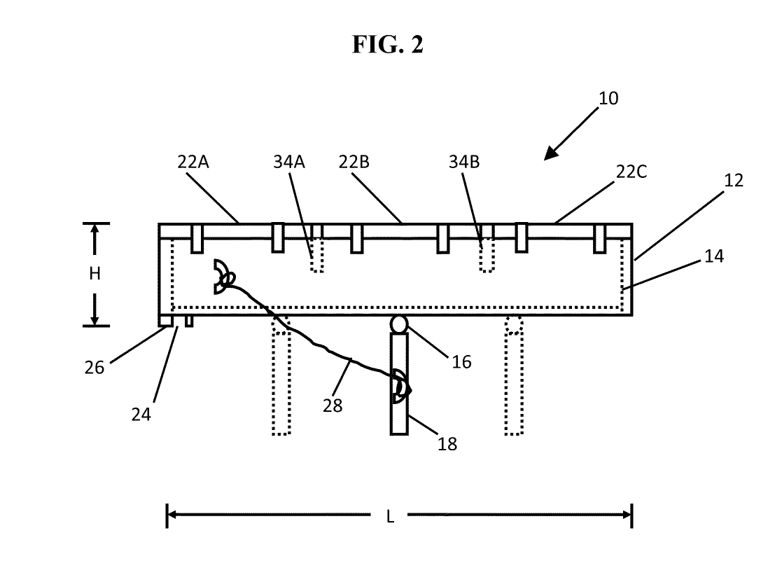

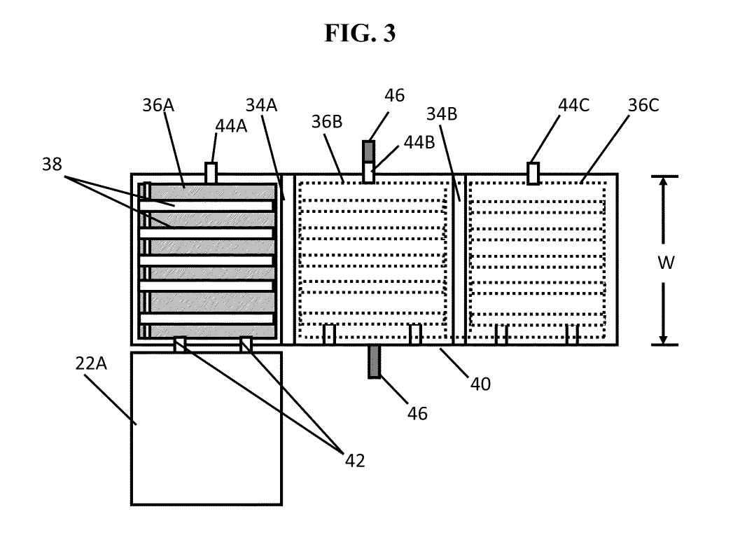

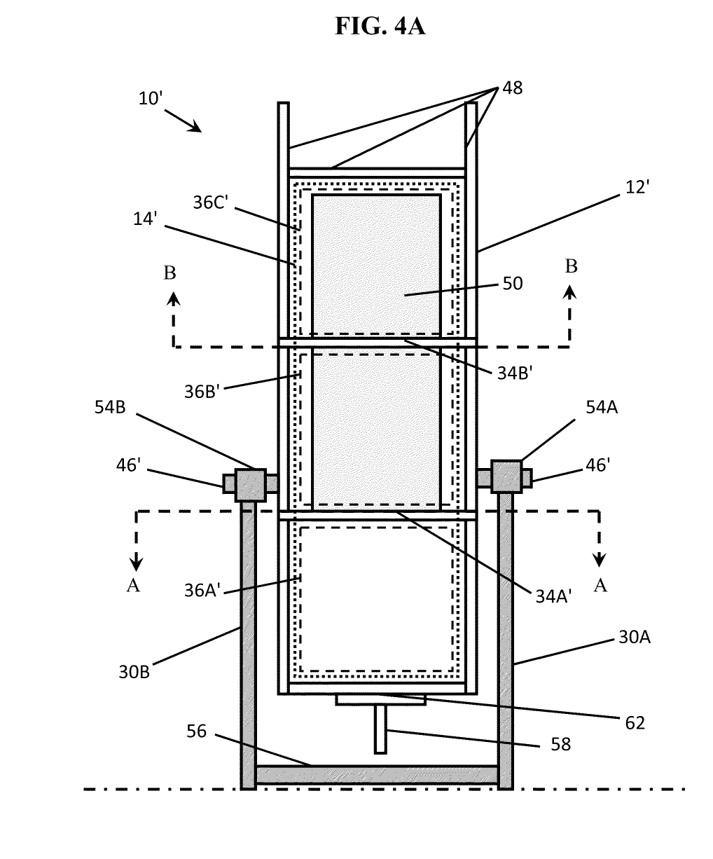

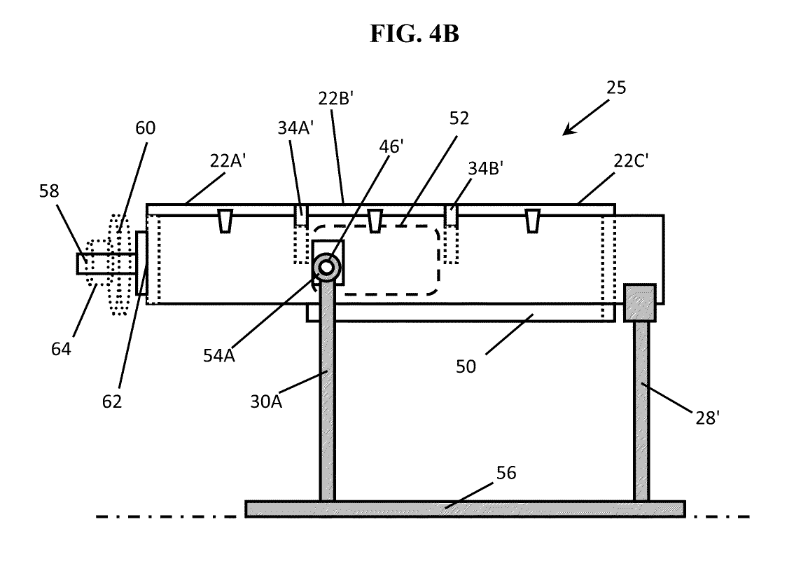

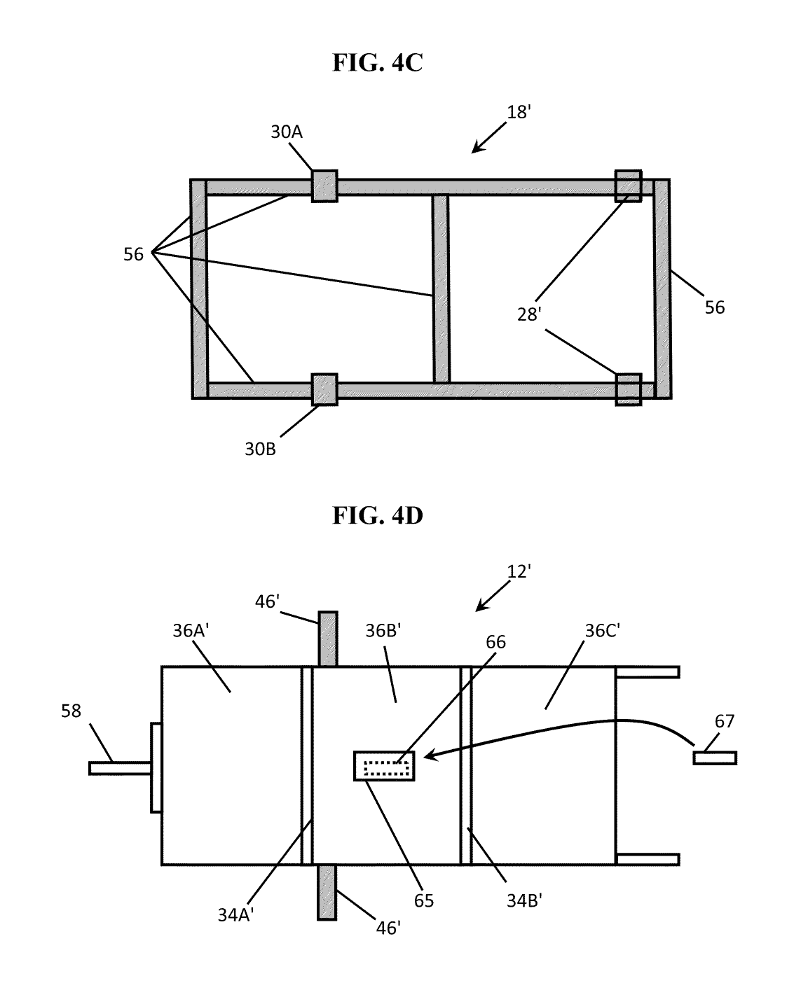

FIGS. 2-3 show somewhat schematic views of the man-made bee housing 10 wherein the primary enclosure 12 further includes a plurality of doors 22 (22A, 22B, and 22C), each of the doors 22 for providing access to the primary compartment 14. The primary compartment 14 includes an entrance aperture 24 through which the bees of a colony can enter and exit the bee hive. Preferably, a landing board 26 is included adjacent the entrance aperture 24 for bees to land on and take off from. A catch member 28 is shown which is used to provide supplemental support for the primary enclosure 12 when the primary enclosure 12 is in a substantially horizontal orientation. The catch member 28, if necessary, can come in a variety of forms including a cable, chain, or other ropelike apparatus limiting the rotation of the primary enclosure 12 as shown in FIG. 2, or, for example, a beam 32 as shown in FIG. 4B offering direct support beneath the primary enclosure 12. Where other external objects of appropriate height are proximate the man-made bee housing 10, such external objects can be used such as, for example, an embankment, a rock, a wall, a table, a bench, and the like. Thus, a catch member 28 is not necessarily a part of every embodiment of the disclosure as there are a variety of external items that can be used for supplemental support of the primary enclosure 12. The man-made bee housing 10 in FIG. 2 also includes a plurality of partial barriers 34 (34A and 34B) for separating a plurality of sub-compartments 36 (36A, 36B, and 36C). The plurality of doors 22 preferably correspond in shape and size to the plurality of sub-compartments 36, respectively. FIG. 2 also shows phantom schematic indicators of the rotation element 16 and the support structure 18 to illustrate that the attachment of the rotation element 16 to the primary enclosure can vary from embodiment to embodiment, most often depending of the type of mechanism used as or with the rotation element 16.

FIG. 3 shows a plurality of frames 38 removably attached to the primary enclosure 12 within the first sub-compartment 34A. FIG. 3 also shows an example of how the plurality of doors 22 can be attached to a side panel 40 of the primary enclosure 12 using a pair of hinges 42. A plurality of latches 44 (44A, 44B, and 44C) is also shown, one hinge connected to each of the doors 22 for latching and, if desired, locking the doors 22 to thereby lock the primary enclosure 12. Although hinges and latches are shown in FIG. 3, other fasteners known to a person having ordinary skill in the art for connecting the plurality of doors 22 to other portion(s) of the primary enclosure 12 are contemplated. FIG. 3 also shows the rotation element 16 in the form of a pair of extension members 46 extending outwardly from opposed sides of the primary enclosure 12.

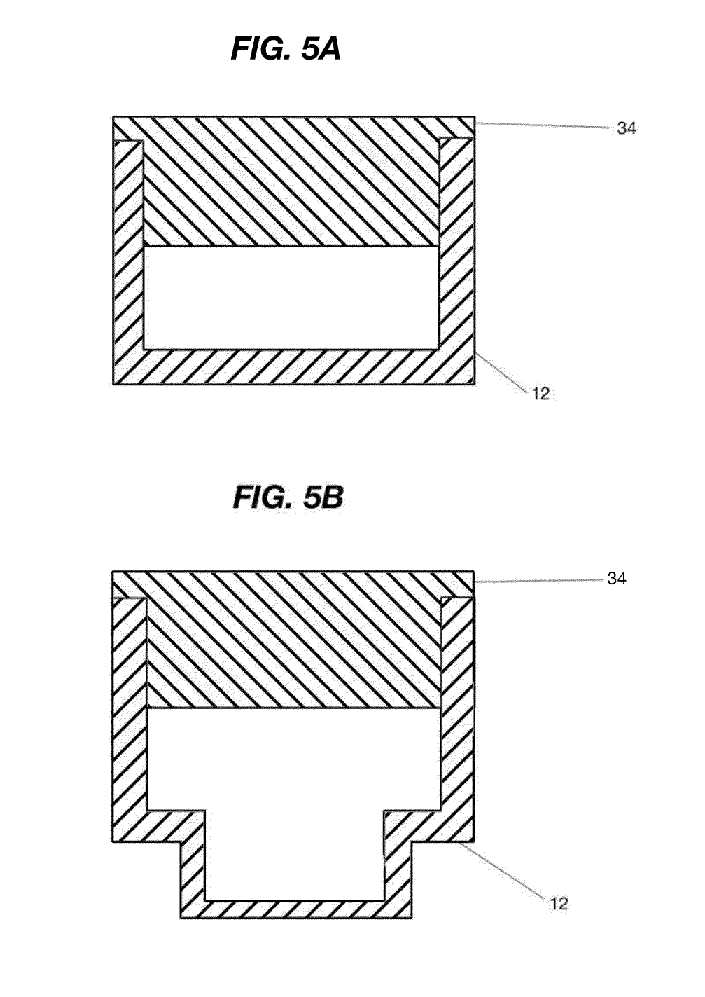

FIGS. 4A-4D show a somewhat schematic view of a man-made bee housing 10′ including a primary enclosure 12′ including a plurality of walls 48 and a plurality of doors 22′ (22A′, 22B′, and 22C′) defining a primary compartment 14′. The primary compartment 14′ includes a plurality of sub-compartments 36′ (36A′, 36B′, and 36C′) separated by a plurality of partial barriers 34′ (34A′ and 34B′). FIG. 5A shows a cross-sectional view cut along line A-A in FIG. 4A and FIG. 5B shows a second cross-sectional view cut along line B-B in FIG. 4A. The respective volumes of the second sub-compartment 36B′ and the third sub-compartment 36C′ are preferably greater than the volume of the first sub-compartment 36A′ due at least in part to the increased depth of the second sub-compartment 36B′ and the third sub-compartment 36C′ as shown by the shaded region 50 in FIGS. 4A and 5B. Preferably, a brood chamber 52 for a bee colony is located in the second sub-compartment 36B′. FIG. 4B shows a support structure 18′ including a catch member 28′ in the form of a supplemental stand and a pair of upright beams 30 (30A AND 30B), each beam including an aperture (54A and 54B) for receiving and engaging with a pair of extension members 46′ extending outwardly from opposed sides of the primary enclosure 12′. The support structure 18′ further includes a base frame 56 as shown in FIG. 4C that provides balance and stability for the overall structure of the man-made bee housing 10′. FIG. 4D shows a plan view of the man-made bee housing 10′ including the pair of extension members 46′ extending outwardly from opposed sides of the primary enclosure 12′ and a weight extension 58 for holding a weight 60 (e.g., conventional barbell weights or the like) to help hold a first end 62 of the primary enclosure 12′ down when the primary enclosure is oriented in a substantially vertical orientation. A holder 64 (e.g., a barbell collar, a spring clip, or the like) can be used to hold the weight 60 along the weight extension 58.

FIGS. 4A and 4D show a cap 65 blocking an insertion aperture 66 preferably located through the second door 22B′. During times when it is necessary to insert a queen bee into the man-made bee housing 10′, the cap 65 can be moved, revealing the insertion aperture 66. A cage 67 including a queen bee can then be inserted into the insertion aperture 66 to introduce the queen bee to the colony dwelling inside the man-made bee housing 10′. After the queen bee has exited the cage 67 and entered the primary compartment 14′, the cage 67 can be removed and the cap 65 moved back to obstruct the insertion aperture. As is known in the art, this transfer process can take a number of hours and preferably one or more days so that the bees in a colony become accustomed to the scent of their new queen before having direct contact with the queen. The cap 65 can act in the form of a plug, a door, or any other similar useful object that could be utilized to obstruct and block the insertion aperture 66.

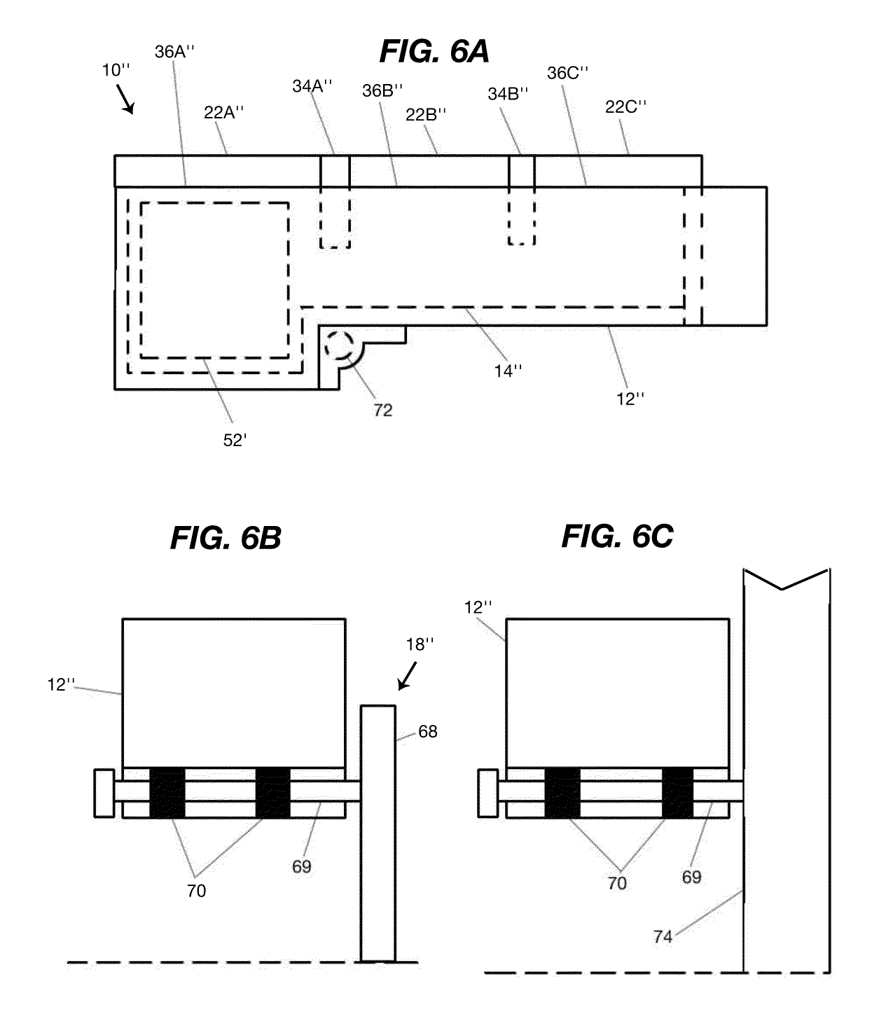

FIGS. 6A-6C show somewhat schematic views of man-made bee housing 10″ including a primary enclosure 12″ and a plurality of doors 22″ (22A″, 22B″, and 22C″) defining a primary compartment 14″. The primary compartment 14″ includes a plurality of sub-compartments 36″ (36A″, 36B″, and 36C″) separated by a plurality of partial barriers 34″ (34A″ and 34B″). FIG. 6B shows a support structure 18″ including a trunk member 68 and an arm member 69 that extends substantially orthogonal from the trunk member 68. A rotation member 16″ is shown including a one or more connectors 70 (e.g., collar bearing, clamp, sleeve, and the like) connected to the primary enclosure 12″ defining one or more coupling apertures 72 through which the arm member 69 extends. The primary enclosure 12″ is rotatable about the arm member 69. FIG. 6C shows another example in which the arm member 69 extends directly from fixed body 74 (e.g., a wall, an embankment, or other structure pre-dating the man-made bee housing 10″. In the scheme presented in FIGS. 6A-6C, a first sub-compartment 36A″ has a volume that is greater than the volume of a second sub-compartment 36W or the third sub-compartment 36C″. The distinction in volume is based on an increased depth of the first sub-compartment 36A″ where a brooding chamber 52′ is preferably located.

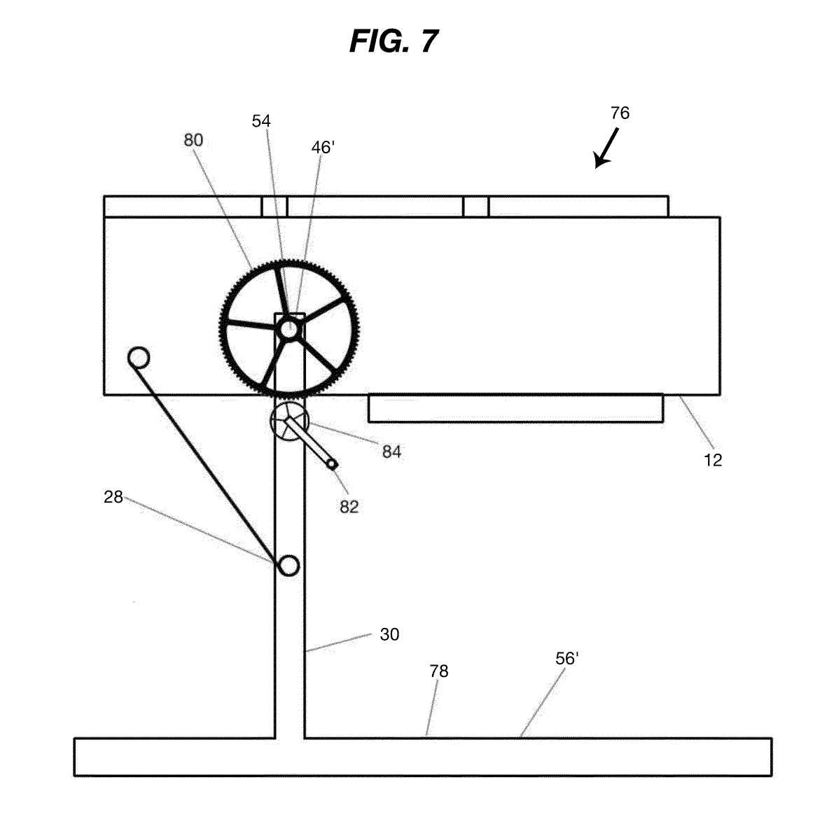

FIG. 7 shows a schematic view of a man-made bee housing 76 including the primary enclosure 12′ of FIGS. 4-5 but wherein the primary enclosure 12′ is connected to an alternate support structure 78 including the catch member 28 and a pair of upright beams 30 (30A AND 30B), each beam including an aperture (54A and 54B) for receiving and engaging with a pair of extension members 46′ extending outwardly from opposed sides of the primary enclosure 12′. The alternate support structure 78 further includes a base frame 56′ that provides balance and stability for the overall structure of the man-made bee housing 76. The man-made bee housing 76 further includes a gear assembly 80 including a hand crank 82 and associated gears 84 for providing mechanical advantage to a user to more easily rotate the primary enclosure 12 about an imaginary axis defined substantially along the pair of extension members 46′.

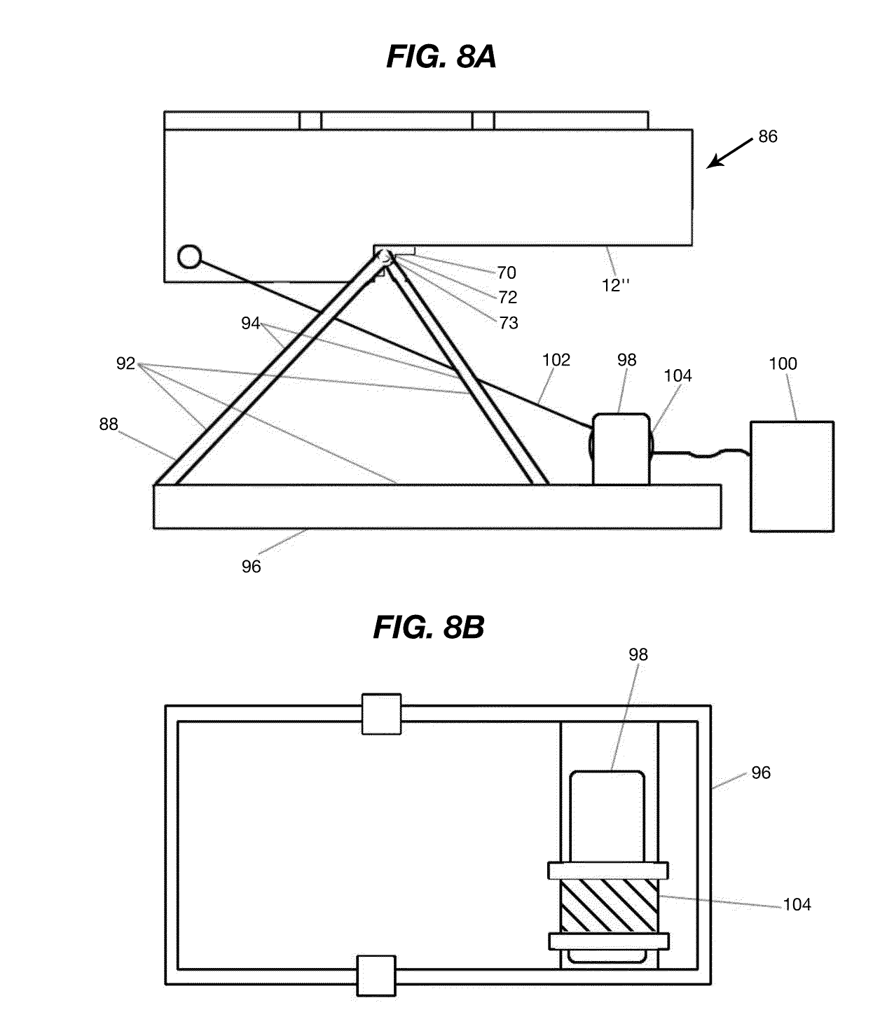

FIGS. 8A-8B show somewhat schematic views of a man-made bee housing 86 including the primary enclosure 12″ connected to an alternate support structure 88. The alternate support structure 88 includes a frame 90 including a plurality of beams 92 which further include side beams 94 and base beams 96. The rotation member 16″ is shown including a one or more connectors 70 (e.g., collar bearing, clamp, sleeve, and the like) connected to the primary enclosure 12″ defining one or more coupling apertures 72 through which a shaft 73 extends. A motor 98 receiving power from a power source 100 is engaged with the primary enclosure 12″ via a cord 102 and associated winding assembly 104. The motor 98 can be used to wind the cord 102 about the winding assembly 104 to rotate the primary enclosure 12″ to a substantially vertical orientation or lower the primary enclosure 12″ to a substantially horizontal orientation. Other related schemes are contemplated wherein the motor 98 is used, for example, to engage a gear assembly (e.g., the gear assembly 80 shown in FIG. 7), thereby rotating the primary enclosure 12″ directly at or proximate the shaft 73.

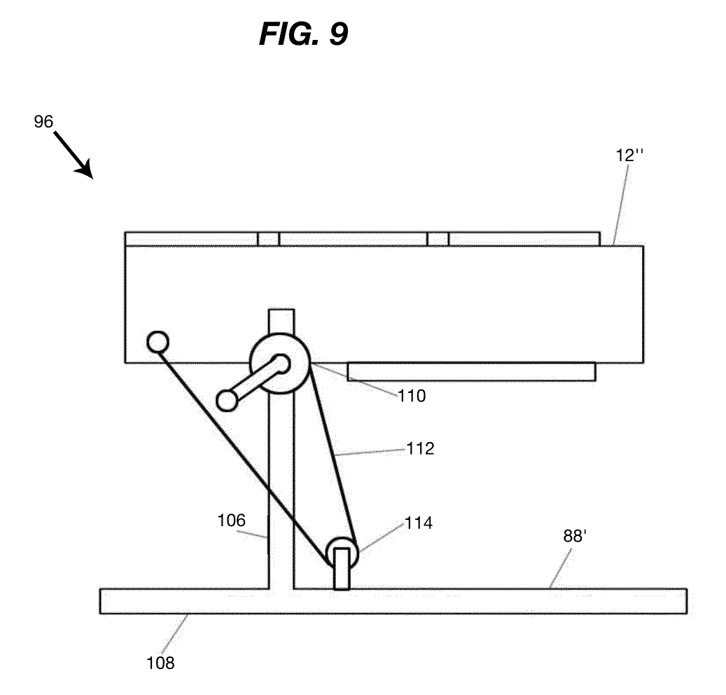

FIG. 9 shows a somewhat schematic view of a man-made bee housing 96 including the primary enclosure 12″ connected to an alternate support structure 88′ including a pair of upright beams 106 attached to a base frame 108 for pivotally supporting the primary enclosure 12″. A hand crank 110 is engaged with the primary enclosure 12″ via a cord 112 and associated pulley 114. The hand crank 110 can be used to wind the cord 112 to rotate the primary enclosure 12″ to a substantially vertical orientation or lower the primary enclosure 12″ to a substantially horizontal orientation. The pulley 114 is preferably connected to one of the upright beams 106 and configured to provide a mechanical advantage to a user using the hand crank 110 when positioning the primary enclosure 12″ in either a substantially vertical or substantially horizontal orientation. However, the pulley 114 can additionally be connected to the base frame 108, primary enclosure 12″, or any other suitable position to provide a mechanical advantage.

For the various schematic examples given herein, the length “L” of the primary enclosure preferably ranges from about 48 inches to about 96 inches and more preferably from about 60 inches to about 84 inches, and most preferably from about 65 inches to about 75 inches. The width “W” of the primary enclosure preferably ranges from about 15 inches to about 36 inches and more preferably from about 20 inches to about 30 inches, and most preferably from about 23 inches to about 26 inches. The height “H” of the primary enclosure preferably ranges from about 6 inches to about 24 inches and more preferably from about 9 inches to about 16 inches, and most preferably from about 10 inches to about 14 inches. The primary compartment and sub-compartments are preferably sized so that common frames used in conventional bee hives can be used in the man-made bee housings described herein. The primary enclosure is preferably made of wood, but other materials of construction are contemplated including, without limitation, plastics and other polymer-based materials. Although many of the support structures described herein include above-ground frames, other examples are contemplated in which support structures extend into and/or are anchored into the surrounding ground. Such anchoring can include, for example, cement or other stabilizing/anchoring material(s). Also, many of the support structures and rotation elements described herein are preferably made of metal or one or more metal alloys. Alternatively or additionally, such support structures and rotation elements can be made composite materials, wood, polymers, and other materials.

The various schematic examples described herein are indicative of a broader range of specific embodiments of man-made bee housing apparatuses, all of which are used to provide easier access to a bee colony living inside such man-made bee housing. The reasons for gaining access vary, but often include taking honey from the bee colony, inspecting the health of the queen bee, and inspecting the health of the bee colony generally. Because bee hives in nature are typically oriented in a substantially vertical orientation, the ability of the man-made bee housing examples described herein to be maintained in such a vertical orientation is more natural to bees living in such man-made bee housings. However, it is difficult to easily access conventional man-made bee housings such as, for example, Langstroth-style housings, that are maintained in a substantially vertical orientation. It is often necessary to manually lift and move portions of the bee housing to access the bee colony to remove honey. Typically, the brooding chamber or “brood box” is at the very bottom of such structures and requires that all layers be manually removed before the queen bee of a bee colony can be inspected. Thus, by providing a mechanism by which a man-made bee housing can be rotated to a substantially horizontal orientation and different sections of such bee housing can be accessed through doors or the like, it is much easier to maintain bee colonies and extract honey from such colonies.

The previously described schematic examples of the present disclosure have many advantages, including providing an easy way for a man-made bee housing to be inspected and for honey to be extracted therefrom. Significantly less strength and manual work is required to maintain such man-made bee housings because there is no need to manually lift and move multiple portions of bee housings as with, for example, common Langstroth bee hives. Such benefits are particularly helpful for older, weaker, and/or physically handicapped individuals that maintain bee colonies for farming or other purposes. By using a gear assembly and or a motor to rotate the primary enclosure of a man-made bee housing as disclosed herein, the advantages are further magnified because even less work is required for bee colony upkeep and honey farming. Various embodiments of man-made bee housings based on the teachings herein benefit from both the advantage of having a bee colony kept in a substantially vertical orientation most of the time as such colonies occur in nature while, at the same time, allowing for easy access to the different compartments of such bee colony when the primary enclosure of such bee housing is rotated to a substantially horizontal orientation.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

Any element in a claim that does not explicitly state “means for” performing a specified function, or “step for” performing a specific function, is not to be interpreted as a “means” or “step” clause as specified in 35 U.S.C. §112, ¶ 6. In particular, the use of “step of” in the claims herein is not intended to invoke the provisions of 35 U.S.C. §112, ¶ 6.

What is claimed is:

1. A man-made bee housing comprising a primary enclosure including a plurality of walls, a first door, and an entrance aperture, the primary enclosure defining a primary compartment, the first door for accessing the primary compartment, and the entrance aperture providing a means of ingress and egress for bees to and from the primary compartment; a rotation element connected to the primary enclosure; and a support structure attached to the rotation element, wherein the primary enclosure is rotatable about an imaginary axis from a substantially vertical orientation to a substantially horizontal orientation and vice versa.

2. The man-made bee housing of claim 1 wherein the door is located along at least a portion of the top of the primary enclosure when the primary compartment is oriented in a substantially horizontal orientation.

3. The man-made bee housing of claim 1 further comprising a catch member for providing supplemental support to the primary enclosure when the primary enclosure is in a substantially horizontal orientation.

4. The man-made bee housing of claim 1 further comprising a plurality of sub-compartments defined within the primary compartment, each sub-compartment separated by a partial barrier, wherein one of the sub-compartments comprises a brooding chamber.

5. The man-made bee housing of claim 1 wherein the rotation element further comprises a coupling member connected to and extending outwardly from a first side panel of the primary enclosure and oriented along the imaginary axis; and wherein the support structure further comprises a first beam including a trunk member and a ring member proximate a first end of the trunk member for engagement with the coupling member, thereby providing a rotational connection between the primary enclosure and the support structure.

6. The man-made bee housing of claim 5 wherein the rotation element further comprises a second coupling member connected to and extending outwardly from a second side panel of the primary enclosure and oriented along the imaginary axis; and wherein the support structure further comprises a second beam including a trunk member and a ring member proximate a first end of the trunk member for engagement with the second coupling member.

7. The man-made bee housing of claim 1 wherein the rotation element further comprises a coupling member connected to the primary enclosure; and wherein the support structure further comprises a first beam including a trunk member and an arm member, the arm member extending substantially orthogonal from the trunk member and oriented along the imaginary axis through an aperture defined at least in part by the coupling member to provide a rotational connection between the primary enclosure and the support structure.

8. The man-made bee housing of claim 1 wherein the rotation element further comprises a coupling member connected to the primary enclosure; and wherein the support structure further comprises an arm member extending substantially horizontally, oriented along the imaginary axis through an aperture defined at least in part by the coupling member to provide a rotational connection between the primary enclosure and the support structure.

9. The man-made bee housing of claim 4 further comprising a plurality of sub-compartments including a first sub-compartment, a second sub-compartment, and a third sub-compartment; wherein the first sub-compartment is located at the lowest elevation when the primary enclosure is oriented in a substantially vertical orientation; and wherein the volume of the sub-compartment comprising the brooding chamber is greater than any other sub-compartment that does not include the brooding chamber.

10. The man-made bee housing of claim 9 wherein the first sub-compartment comprises the brooding chamber.

11. The man-made bee housing of claim 4 further comprising a plurality of sub-compartments including a first sub-compartment, a second sub-compartment including the brooding chamber, and a third sub-compartment; wherein the first sub-compartment is located at the lowest elevation when the primary enclosure is oriented at a substantially vertical orientation; wherein the volume of the second sub-compartment is greater than the volume of the first sub-compartment and wherein the volume of the third sub-compartment is greater than the volume of the first sub-compartment.

12. The man-made bee housing of claim 9 further comprising a second door and a third door, wherein the first door provides access to the first sub-compartment, the second door provides access to the second sub-compartment, and the third door provides access to the third sub-compartment.

13. The man-made bee housing of claim 1 further comprising a plurality of frames removably attached to the primary enclosure inside the primary compartment.

14. The man-made bee housing of claim 1 further comprising a landing board extending outwardly adjacent the entrance aperture.

15. The man-made bee housing of claim 1 further comprising a gear assembly including a hand crank, the gear assembly connected to the primary enclosure and providing mechanical advantage for a user to rotate the primary enclosure from a substantially vertical orientation to a substantially horizontal orientation and vice versa.

16. The man-made bee housing of claim 1 further comprising a gear assembly connected to the primary enclosure and an electric motor mechanically engaged with the gear assembly, the gear assembly providing mechanical advantage and the electric motor providing automation for rotating the primary enclosure from a substantially vertical orientation to a substantially horizontal orientation and vice versa.

17. The man-made bee housing of claim 1 further comprising a pulley assembly connected to the man-made bee housing, the pulley assembly providing mechanical advantage for rotating the primary enclosure from a substantially vertical orientation to a substantially horizontal orientation and vice versa.

18. The man-made bee housing of claim 1 further comprising a cord connected to the primary enclosure and wound about a spool; and an electric motor for winding and unwinding the cord along the spool to rotate the primary enclosure from a substantially vertical orientation to a substantially horizontal orientation and vice versa.

19. The man-made bee housing of claim 4 wherein the first door further comprises an insertion aperture and a cap for blocking the insertion aperture, the insertion aperture sized and shaped to hold a cage used to introduce a new queen bee to any colony of bees housed within the man-made bee housing, the cage temporarily housing a queen bee and including an exit aperture facing the primary compartment.
